(19) United States
(12) Patent Application Publication
(10) Pub. No.: US 2024/0392172 A1
(43) Pub. Date: Nov. 28, 2024

(54) PRESSURE-SENSITIVE ADHESIVE COMPOSITION AND PRESSURE-SENSITIVE ADHESIVE SHEET USING SAID PRESSURE-SENSITIVE ADHESIVE COMPOSITION

(71) Applicant: NITTO DENKO CORPORATION, Ibaraki-shi, Osaka (JP)

(72) Inventors: Yusuke TAKEDA, Ibaraki-shi, Osaka (JP); Satoshi HONDA, Ibaraki-shi, Osaka (JP); Kenta KUMAKURA, Ibaraki-shi, Osaka (JP); Naofumi KOSAKA, Ibaraki-shi, Osaka (JP)

(21) Appl. No.: 18/696,005

(22) PCT Filed: Sep. 21, 2022
(86) PCT No.: PCT/JP2022/035086

§ 371 Date: Mar. 27, 2024

(30) Foreign Application Priority Data
Sep. 29, 2021 (JP) 2021-160104

(51) Int. Cl. C09J 133/04; C09J 7/38; C09J 11/08

(52) U.S. Cl. CPC C09J 133/04; C09J 7/385; C09J 11/08; C09J 2301/302; C09J 2301/414; C09J 2301/502; C09J 2433/00

(57) ABSTRACT

The present invention provides a pressure-sensitive adhesive composition having an excellent pressure-sensitive adhesive force to an adherend even in a high temperature, enabling peeling with a small peel force without any adhesive residue when brought into contact with warm water during peeling, and having a pressure-sensitive adhesive force and easy peelability. The pressure-sensitive adhesive composition according to the present invention contains: an acrylic polymer containing a structural unit of an alkoxy group-containing (meth)acrylate monomer as a main component and containing, with respect to 100 parts by mass of all components of monomer structural units, 1 to 40 parts by mass of a structural unit of a polymerizable monomer having a homopolymer Tg of 0° C. or higher; and a surfactant.

### TECHNICAL FIELD

The present invention relates to a pressure-sensitive adhesive composition, and a pressure-sensitive adhesive sheet using the pressure-sensitive adhesive composition.

### BACKGROUND ART

In the related art, pressure-sensitive adhesive sheets such as a pressure-sensitive adhesive tape and a pressure-sensitive adhesive label have been used in various fields. For example, when a heat treatment is performed in the production of various industrial products, a pressure-sensitive adhesive sheet is attached to a portion to be avoided from direct heating, and the pressure-sensitive adhesive sheet is peeled from the surface of an adherend after the heat treatment.

As such a pressure-sensitive adhesive sheet in the related art used for heat-resistant masking, those containing a carbon-based polymer in a pressure-sensitive adhesive layer are used. When it is heated at a high temperature of 130° C. or higher together with an adherend such as a glass or a metal, the attraction of an intermolecular force of carbon becomes strong, and the pressure-sensitive adhesive layer may be attracted to the surface of the adherend, making it difficult to peel the pressure-sensitive adhesive sheet.

On the other hand, when peeling the pressure-sensitive adhesive sheet, warm water is used for peeling, and various pressure-sensitive adhesive compositions that enable peeling in warm water have been proposed. For example, Patent Literature 1 proposes a pressure-sensitive adhesion composition containing a N-mono- or di-C₂ to C₄ alkyl-substituted acrylamide macromonomer having a viscosity average molecular weight of 250 to 1000 in acrylic pressure-sensitive adhesive whose main component is a (meth)acrylic acid alkyl ester resin. In addition, Patent Literature 2 proposes a warm water peelable adhesive resin composition, which contains an epoxy resin and a compound having two or more mercapto groups and a molecular weight of 800 or less.

### CITATION LIST

### Patent Literature

Patent Literature 1: JP2006-241264A
Patent Literature 2: JP2011-057870A

### SUMMARY OF INVENTION

### Technical Problem

However, the warm water peelable pressure-sensitive adhesive compositions described in Patent Literatures 1 and 2 are not expected to be subjected to high temperature heating, and a pressure-sensitive adhesive force and peelability thereof during a heat treatment are unknown. A pressure-sensitive adhesive sheet used for a heat treatment is required to have not only heat resistance but also easy peelability after a heat treatment.

Therefore, an object of the present invention is to provide a pressure-sensitive adhesive composition having an excellent pressure-sensitive adhesive force to an adherend even in a high temperature, enabling peeling with a small peel force without any adhesive residue when brought into contact with warm water during peeling, and having a pressure-sensitive adhesive force and easy peelability.

### Solution to Problem

As a result of extensive research, the inventors of the present invention have found that a pressure-sensitive adhesive composition containing an acrylic polymer having a specific structure and a surfactant has heat resistance, an excellent pressure-sensitive adhesive force to an adherend and excellent peelability after a treatment in warm water. Thus, the present invention has been completed.

That is, the present invention relates to the following (1) to (7).
(1) A pressure-sensitive adhesive composition containing:
an acrylic polymer containing a structural unit of an alkoxy group-containing (meth)acrylate monomer as a main component and containing, with respect to 100 parts by mass of all components of monomer structural units, 1 to 40 parts by mass of a structural unit of a polymerizable monomer having a homopolymer Tg of 0° C. or higher; and
a surfactant.
(2) The pressure-sensitive adhesive composition according to the above (1), in which the surfactant is a nonionic surfactant.
(3) The pressure-sensitive adhesive composition according to the above (1) or (2), in which the alkoxy group-containing (meth)acrylate monomer is at least one selected from the group consisting of methoxyethyl acrylate, ethoxyethoxyethyl acrylate, polyethylene glycol acrylate, and polypropylene glycol acrylate.
(4) The pressure-sensitive adhesive composition according to any one of the above (1) to (3), in which a contact angle with water when the pressure-sensitive adhesive composition is formed into a cured film is 80 degrees or less.
(5) A pressure-sensitive adhesive sheet including:
a pressure-sensitive adhesive layer formed of the pressure-sensitive adhesive composition according to any one of the above (1) to (4).
(6) A peeling method for a pressure-sensitive adhesive sheet, which is for peeling the pressure-sensitive adhesive sheet according to the above (5) which is attached to an adherend, the peeling method including:
a step of bringing the adherend, to which the pressure-sensitive adhesive sheet is attached and which is subjected to a heat treatment at 130° C. to 250° C., into contact with warm water at 40° C. to 90° C. and peeling the adherend and the pressure-sensitive adhesive sheet at an interface therebetween.
(7) The peeling method for a pressure-sensitive adhesive sheet according to the above (6), in which the adherend to which the pressure-sensitive adhesive sheet is attached is brought into contact with the warm water for 1 minute or longer.

### Advantageous Effects of Invention

The pressure-sensitive adhesive composition according to the present invention has excellent heat resistance and pressure-sensitive adhesive force, and has a decrease in pressure-sensitive adhesive force when it comes into contact with warm water after heating. Therefore, a pressure-sensitive adhesive sheet including a pressure-sensitive adhesive layer formed of the pressure-sensitive adhesive composition according to the present invention has excellent pressure-sensitive adhesiveness to an adherend, and can be peeled from the adherend with a small peel force by being brought into contact with warm water after a heat treatment.

### DESCRIPTION OF EMBODIMENTS

Hereinafter, embodiments of the present invention will be described in more detail, but the present invention is not limited to the following embodiments.

Note that, in the present description, “(meth)acrylate” refers to acrylate and/or methacrylate.

In addition, in the present description, “mass” has the same meaning as “weight”.

### [Pressure-Sensitive Adhesive Composition]

A pressure-sensitive adhesive composition according to an embodiment of the present invention contains: an acrylic polymer containing a structural unit of an alkoxy group-containing (meth)acrylate monomer as a main component and containing, with respect to 100 parts by mass of all components of monomer structural units, 1 to 40 parts by mass of a structural unit of a polymerizable monomer having a homopolymer Tg of 0° C. or higher; and a surfactant.

### (Acrylic Polymer)

The acrylic polymer contained in the pressure-sensitive adhesive composition according to the embodiment of the present invention is obtained by polymerizing monomer components including an alkoxy group-containing (meth)acrylate monomer and a polymerizable monomer whose glass transition temperature (Tg) of a homopolymer is 0° C. or higher.

The alkoxy group-containing (meth)acrylate monomer is a monomer containing an alkoxy group in the structure, and examples thereof include a compound represented by the following formula (1).

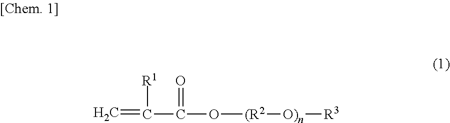

In the general formula (1), R¹ represents a hydrogen atom or a methyl group, R² represents an alkylene group having 2 to 5 carbon atoms, R³ represents an alkyl group having 1 to 12 carbon atoms, a benzyl group, or a biphenyl group, and n represents an integer of 1 to 12.

Specific examples of the alkoxy group-containing (meth)acrylate monomer include methoxyethyl acrylate, ethoxyethoxyethyl acrylate, methoxy-triethylene glycol acrylate, 2-ethylhexyl-diglycol acrylate, methoxy-polyethylene glycol acrylate, methoxydipropylene glycol acrylate, phenoxyethyl acrylate, phenoxydiethylene glycol acrylate, phenoxy-polyethylene glycol acrylate, ethoxylated-O-phenylphenol acrylate, polyethylene glycol acrylate, and polypropylene glycol acrylate. The alkoxy group-containing (meth)acrylate monomer may be used alone or in combination of two or more types thereof.

Among them, from the viewpoint of the adhesiveness, it is preferable to use at least one selected from the group consisting of methoxyethyl acrylate, ethoxyethoxyethyl acrylate, polyethylene glycol acrylate, and polypropylene glycol acrylate.

The alkoxy group-containing (meth)acrylate monomer is contained as a main component in the acrylic polymer. Note that, in the present description, unless otherwise specified, the “main component” refers to a component contained in an amount of more than 50 mass %, preferably 60 mass % or more, and more preferably 70 mass % or more.

The structural unit of the alkoxy group-containing (meth)acrylate monomer is preferably contained in the range of 50 to 99 parts by mass with respect to 100 parts by mass of all components of monomer structural units. When the structural unit of the alkoxy group-containing (meth)acrylate monomer is 50 parts by mass or more, the pressure-sensitive adhesive composition can exhibit heat resistance. When the structural unit of the alkoxy group-containing (meth)acrylate monomer is 99 parts by mass or less, a cohesive force of a pressure-sensitive adhesive can be increased and an adhesive residue can be reduced by adding a high Tg monomer. The content of the structural unit of the alkoxy group-containing (meth)acrylate monomer is more preferably 60 parts by mass or more, still more preferably 70 parts by mass or more, and is more preferably 97 parts by mass or less, still more preferably 95 parts by mass or less, with respect to 100 parts by mass of all components of monomer structural units. 20 The polymerizable monomer having a homopolymer Tg of 0° C. or higher is a monomer having at least one polymerizable unsaturated double bond in one molecule. The acrylic polymer according to the present invention obtained by containing, as a component, the polymerizable monomer having a homopolymer Tg of 0° C. or higher has characteristics of increasing the cohesive force of the pressure-sensitive adhesive and reducing the adhesive residue. Therefore, the pressure-sensitive adhesive composition containing the acrylic polymer according to the present invention easily swells in warm water.

Examples of the polymerizable monomer having a homopolymer Tg of 0° C. or higher include N-vinyl-2-pyrrolidone, acrylic acid, methyl (meth)acrylate, ethyl methacrylate, propyl methacrylate, isopropyl methacrylate, n-butyl methacrylate, isobutyl methacrylate, s-butyl methacrylate, t-butyl methacrylate, pentyl methacrylate, isopentyl methacrylate, hexyl methacrylate, tridecyl acrylate, tetradecyl acrylate, pentadecyl (meth)acrylate, hexadecyl (meth)acrylate, heptadecyl (meth)acrylate, stearyl (meth)acrylate, isostearyl (meth)acrylate, nonadecyl (meth)acrylate, eicosyl acrylate, dicyclopentanyl methacrylate, β-carboxyethyl acrylate, 2-hydroxy-3-phenoxypropyl acrylate, acrylonitrile, acrylamide, dimethylacrylamide, isopropylacrylamide, hydroxyethylacrylamide, hydroxymethylacrylamide, hydroxybutylacrylamide, acryloylmorpholine, and 1-vinylimidazole. The polymerizable monomer may be used alone or in combination of two or more types thereof.

The polymerizable monomer is preferably at least one selected from acrylic acid and N-vinyl-2-pyrrolidone, from the viewpoint of better exhibiting the effects of the present invention.

The structural unit of the polymerizable monomer having a homopolymer Tg of 0° C. or higher is contained in the range of 1 to 40 parts by mass with respect to 100 parts by mass of all components of monomer structural units. When the structural unit of the polymerizable monomer is 1 part by mass or more, the cohesive force of the pressure-sensitive adhesive can be increased and the adhesive residue can be reduced. When the structural unit of the polymerizable monomer is 40 parts by mass or less, an adhesion function as a pressure-sensitive adhesive is not impaired. The content of the structural unit of the polymerizable monomer is preferably 3 parts by mass or more, more preferably 5 parts by mass or more, and is preferably 30 parts by mass or less, more preferably 20 parts by mass or less, with respect to 100 parts by mass of all components of monomer structural units.

Note that, in the present description, the polymer Tg refers to a nominal value described in literature, catalogs, or the like, or a Tg (also referred to as calculated Tg) determined by the FOX formula based on a composition of monomer components used for preparing the polymer. The Fox formula is, as shown below, a relational formula between a Tg of a copolymer and a glass transition temperature Tgi of a homopolymer obtained by homopolymerizing each monomer constituting the copolymer.

1/Tg=Σ(Wi/Tgi)

In the above Fox formula, Tg represents a glass transition temperature (unit: K) of the copolymer, Wi represents a weight fraction (copolymerization ratio on a weight basis) of a monomer i in the copolymer, and Tgi represents a glass transition temperature (unit: K) of a homopolymer of the monomer i. When a target polymer whose Tg is specified is a homopolymer, the Tg of the homopolymer matches the Tg of the target polymer.

As the glass transition temperature of the homopolymer used for calculation of Tg, values described in known materials are used. Specifically, numerical values are listed in “Polymer Handbook” (3ed, John Wiley & Sons, Inc., 1989). For a monomer for which multiple values are listed in the above Polymer Handbook, the highest value is used.

As for a monomer in which the glass transition temperature of the homopolymer is not described in the above literature “Polymer Handbook”, values obtained by the following measurement method are used. Specifically, to a reactor equipped with a thermometer, a stirrer, a nitrogen introduction tube, and a reflux cooling tube, 100 parts by mass of a monomer, 0.2 parts by mass of 2,2′-azobisisobutyronitrile, and 200 parts by mass of ethyl acetate as a polymerization solvent are charged, and the mixture is stirred for 1 hour while circulating a nitrogen gas. In this way, oxygen in the polymerization system is removed, then the temperature is raised to 63° C., and the reaction is carried out for 10 hours. Next, the mixture is cooled to room temperature to obtain a homopolymer solution having a solid content concentration of 33 mass %. Next, this homopolymer solution is cast and applied on a peel liner and the coated peel liner is dried to prepare a test sample (sheet-shaped homopolymer) having a thickness of about 2 mm. The test sample is punched out into a disk shape having a diameter of 7.9 mm, sandwiched between parallel plates, and subjected to measurement of viscoelasticity in a shear mode at a heating rate of 5° C./min in a temperature range of −70° C. to 150° C. while applying a shear strain at a frequency of 1 Hz using a viscoelasticity tester (model name “ARES”, manufactured by TA Instruments), and a temperature corresponding to the peak top temperature of tan δ is defined as the homopolymer Tg.

The acrylic polymer may contain monomer components other than the alkoxy group-containing (meth)acrylate monomer and the polymerizable monomer having a homopolymer Tg of 0° C. or higher described above. Examples of the other monomer components include ethyl acrylate, propyl acrylate, isopropyl acrylate, n-butyl acrylate, isobutyl acrylate, s-butyl acrylate, t-butyl acrylate, pentyl acrylate, isopentyl acrylate, hexyl acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl methacrylate, and tetradecyl methacrylate.

In the production of the acrylic polymer, it is preferable that the alkoxy group-containing (meth)acrylate monomer, the polymerizable monomer having a homopolymer Tg of 0° C. or higher, and optionally other monomer components are subjected to a polymerization reaction in the presence of a polymerization initiator.

As the polymerization initiator, for example, hydrogen peroxide; persulfates such as sodium persulfate, potassium persulfate, and ammonium persulfate; azo-based compounds such as dimethyl 2,2′-azobis(2-methylpropionate) and 2,2′-azobis(isobutyronitrile); and organic peroxides such as benzoyl peroxide, peracetic acid, and di-t-butyl peroxide are suitable. The polymerization initiators may be used alone or in combination of two or more types thereof.

The amount of the polymerization initiator used is preferably 0.05 to 0.5 parts by mass, more preferably 0.1 to 0.4 parts by mass, and still more preferably 0.2 to 0.5 parts by mass, with respect to 100 parts by mass of all components of monomer structural units.

For the production of such an acrylic polymer, known production methods such as solution polymerization, bulk polymerization, emulsion polymerization, and various radical polymerizations can be appropriately selected. The obtained acrylic polymer may be a random copolymer, a block copolymer, a graft copolymer, or the like.

Note that, in the solution polymerization, for example, ethyl acetate or toluene is used as a polymerization solvent. As a specific example of the solution polymerization, the reaction is carried out under a stream of an inert gas such as nitrogen, with the addition of a polymerization initiator, and generally at about 50° C. to 80° C. for about 1 to 8 hours, which are reaction conditions.

The acrylic polymer for use in the present invention preferably has a weight average molecular weight (Mw) of 200,000 to 3,000,000. Considering the durability, particularly the heat resistance, the weight average molecular weight (Mw) is more preferably 400,000 to 2,500,000, and still more preferably 500,000 to 2,000,000. A weight average molecular weight (Mw) of less than 200,000 is not preferred from the viewpoint of the heat resistance. In addition, when the weight average molecular weight (Mw) is more than 3,000,000, the pressure-sensitive adhesive layer tends to be hard and peeling tends to occur. Note that, the weight average molecular weight (Mw) is measured by GPC (gel permeation chromatography) and determined based on the value calculated in terms of polystyrene.

The acrylic polymer has a glass transition temperature (Tg) of preferably 0° C. or lower (generally −100° C. or higher), more preferably −5° C. or lower, and still more preferably −10° C. or lower. When the glass transition temperature is higher than 0° C., the cohesive force is increased and fluidity decreases, and a sufficient pressure-sensitive adhesive area may not be obtained and the adherend may not be fixed. Particularly, it is preferable that the Tg is −5° C. or lower because the acrylic polymer is soft and a sufficient peel force can be obtained. Note that, the glass transition temperature of the acrylic polymer can be adjusted within the above range by appropriately changing the monomer components and composition ratio used. For the glass transition temperature of the acrylic polymer in the present invention, a measurement method using a dynamic viscoelasticity apparatus, a calculated value using the FOX formula or the like can be used.

### (Surfactant)

As the surfactant contained in the pressure-sensitive adhesive composition according to the embodiment of the present invention, a nonionic surfactant, an anionic surfactant, a cationic surfactant, and an amphoteric surfactant can be used. When the pressure-sensitive adhesive composition contains a surfactant, during peeling after contact with warm water, peeling can be performed with a small force, and the peelability is improved.

Examples of the nonionic surfactant include: polyoxyalkylene alkyl ethers such as polyoxyethylene lauryl ether and polyoxyethylene stearyl ether; polyoxyethylene alkylphenyl ethers such as polyoxyethylene octylphenyl ether and polyoxyethylene nonylphenyl ether; sorbitan fatty acid esters such as sorbitan monolaurate, sorbitan monostearate, and polyoxyethylene sorbitan monolaurate; polyoxyethylene glyceryl ether fatty acid esters; and polyoxyalkylenes such as a polyoxyethylene-polyoxypropylene block copolymer, polyoxyethylene, polyoxypropylene, and polyoxybutylene.

Examples of the anionic surfactant include: alkyl sulfates such as lauryl sulfate and octadecyl sulfate: fatty acid salts: alkylbenzene sulfonates such as nonylbenzene sulfonate and dodecylbenzene sulfonate: naphthalene sulfonates such as dodecylnaphthalene sulfonate; alkyldiphenyl ether disulfonates such as dodecyl diphenyl ether disulfonate: polyoxyethylene alkyl ether sulfates such as polyoxyethylene octadecyl ether sulfate and polyoxyethylene lauryl ether sulfate: polyoxyethylene alkylphenyl ether sulfates such as polyoxyethylene lauryl phenyl ether sulfates: polyoxyethylene styrenated phenyl ether sulfates: sulfosuccinates such as lauryl sulfosuccinate and polyoxyethylene lauryl sulfosuccinate: polyoxyethylene alkyl ether phosphates; and polyoxyethylene alkyl ether acetates.

Examples of the cationic surfactant include an alkyldimethylbenzylammonium chloride, an alkyltrimethylammonium chloride, an alkyldimethylethylammonium ethyl sulfate, a higher alkylamine salt (such as acetate hydrochloride), an ethylene oxide adduct to a higher alkylamine, a condensate of a higher fatty acid and a polyalkylene polyamine, a salt of an ester of a higher fatty acid and an alkanolamine, a higher fatty acid amide salt, an imidazoline type cationic surfactant, and an alkylpyridinium salt.

Examples of the amphoteric surfactant include amino acid type amphoteric surfactants such as an alkylaminopropionic acid alkali metal salt, betaine-type amphoteric surfactants such as an alkyl dimethyl betaine, and an imidazoline type amphoteric surfactant.

The surfactant may be used alone or in combination of two or more types thereof. Among them, from the viewpoint of miscibility into the pressure-sensitive adhesive composition, a nonionic surfactant is preferred, and a sorbitan fatty acid ester, a polyoxyalkylene alkyl ether, and a polyoxyalkylene are more preferred.

The content of the surfactant is preferably 0.3 to 10 parts by mass per 100 parts by mass of the acrylic polymer. When the content of the surfactant is 0.3 parts by mass or more with respect to 100 parts by mass of the acrylic polymer, the resin composition swells easily when it comes into contact with warm water, and therefore peeling can be performed with a small force during the peeling. When the content is 10 parts by mass or less, the initial peel force can be maintained high. The content of the surfactant is more preferably 0.5 parts by mass or more, still more preferably 1 part by mass or more, and is more preferably 7 parts by mass or less, still more preferably 5 parts by mass or less.

### (Crosslinking Agent)

In the present embodiment, the pressure-sensitive adhesive composition may contain a crosslinking agent. The type of the crosslinking agent is not particularly limited, and can be appropriately selected from crosslinking agents known in the related art. Examples of such a crosslinking agent include an isocyanate-based crosslinking agent, an epoxy-based crosslinking agent, an oxazoline-based crosslinking agent, an aziridine-based crosslinking agent, a melamine-based crosslinking agent, a peroxide-based crosslinking agent, a urea-based crosslinking agent, a metal alkoxide-based crosslinking agent, a metal chelate-based crosslinking agent, a metal salt-based crosslinking agent, a carbodiimide-based crosslinking agent, a hydrazine-based crosslinking agent, an amine-based crosslinking agent, and a silane coupling agent. Among them, an isocyanate-based crosslinking agent, an epoxy-based crosslinking agent, an oxazoline-based crosslinking agent, an aziridine-based crosslinking agent, and a melamine-based crosslinking agent are preferred, and an isocyanate-based crosslinking agent and an epoxy-based crosslinking agent are more preferred. With the use of an isocyanate-based crosslinking agent, there is a tendency that impact resistance better than that of other crosslinking agents can be obtained while maintaining the cohesive force of the pressure-sensitive adhesive layer. Further, the use of an isocyanate-based crosslinking agent is advantageous in terms of improving the adhesive strength to an adherend made of a polyester resin such as PET. The crosslinking agent may be used alone or in combination of two or more types thereof.

As the isocyanate-based crosslinking agent, a polyfunctional isocyanate (referring to a compound having an average of two or more isocyanate groups per molecule, including those having an isocyanurate structure) can be preferably used.

Examples of the polyfunctional isocyanate include aliphatic polyisocyanates, alicyclic polyisocyanates, and aromatic polyisocyanates.

Specific examples of the aliphatic polyisocyanates include: 1,2-ethylene diisocyanate; tetramethylene diisocyanates such as 1,2-tetramethylene diisocyanate, 1,3-tetramethylene diisocyanate, and 1,4-tetramethylene diisocyanate; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, and 2,5-hexamethylene diisocyanate; 2-methyl-1,5-pentane diisocyanate; 3-methyl-1,5-pentane diisocyanate; and lysine diisocyanate.

Specific examples of the alicyclic polyisocyanates include: isophorone diisocyanate; cyclohexyl diisocyanates such as 1,2-cyclohexyl diisocyanate, 1,3-cyclohexyl diisocyanate, and 1,4-cyclohexyl diisocyanate; cyclopentyl diisocyanates such as 1,2-cyclopentyl diisocyanate and 1,3-cyclopentyl diisocyanate; hydrogenated xylylene diisocyanate; hydrogenated tolylene diisocyanate; hydrogenated diphenylmethane diisocyanate; hydrogenated tetramethylxylene diisocyanate; and 4,4′-dicyclohexylmethane diisocyanate.

Specific examples of the aromatic polyisocyanates include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, and xylylene-1,3-diisocyanate.

As the isocyanate-based crosslinking agent, for example, commercially available products such as “Coronate L”, “Coronate HL”, and “Coronate HX” manufactured by Nippon Polyurethane Industries, Ltd. can be used.

Examples of the epoxy-based crosslinking agent include a polyfunctional epoxy compound having two or more epoxy groups in one molecule. The epoxy group in the epoxy-based crosslinking agent may be a glycidyl group. Examples of the epoxy-based crosslinking agent include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcin diglycidyl ether, and bisphenol-S-diglycidyl ether.

As the epoxy-based crosslinking agent, for example, commercially available products such as “DENACOL” manufactured by Nagase ChemteX Corporation, and “TETRAD-X” and “TETRAD-C” manufactured by Mitsubishi Gas Chemical Trading, Inc. can be used.

The content of the crosslinking agent is preferably 0.01 to 10 parts by mass per 100 parts by mass of the acrylic polymer. When the content of the crosslinking agent is 0.01 parts by mass or more with respect to 100 parts by mass of the acrylic polymer, the cohesive force of the pressure-sensitive adhesive can be increased. When the content is 10 parts by mass or less, the peel force before heating can be maintained high. The content of the crosslinking agent is more preferably 0.05 parts by mass or more, still more preferably 0.1 parts by mass or more, and is more preferably 7 parts by mass or less, still more preferably 5 parts by mass or less.

### (Thermal Polymerization Initiator)

The pressure-sensitive adhesive composition according to the present invention may contain a thermal polymerization initiator that generates a radical by heating. Examples of such a thermal polymerization initiator include a peroxide, an azo-based compound, a dihalogen-based compound, an alkylphenone-based compound, and an acylphosphine oxide-based compound. Among them, a peroxide and an azo-based compound are preferred from the viewpoints of the durability and the price. The thermal polymerization initiator may be used alone or in combination of two or more types thereof.

Examples of the peroxide include benzoyl peroxide, 1,1-bis(t-hexylperoxy)cyclohexane, cyclohexanone peroxide, 3,3,5-trimethylcyclohexanone peroxide, methylcyclohexanone peroxide, 1,1-bis(t-butylperoxy)-3,3,5-trimethylcyclohexane, 1,1-bis(t-butylperoxy)cyclohexane, n-butyl-4,4-bis(t-butylperoxy) valerate, cumene hydroperoxide, 2,5-dimethylhexane-2,5-dihydroperoxide, 1,3-bis(t-butylperoxy)-m-isopropyl)benzene, 2,5-dimethyl-2,5-di(t-butylperoxy) hexane, diisopropylbenzene peroxide, t-butylcumyl peroxide, peroxide, decanoyl lauroyl peroxide, 2,4-dichlorobenzoyl peroxide, bis(t-butylcyclohexyl) peroxydicarbonate, t-butylperoxybenzoate, and 2,5-dimethyl-2,5-di(benzoylperoxy) hexane.

Examples of the azo-based compound include 2,2′-azobis(isobutyronitrile), 1,1-azobis(cyclohexane-1-carbonitrile), azocumene, 2,2′-azobis(2-methylbutyronitrile), 2,2′-azobisdimethylvaleronitrile, 4,4′-azobis(4-cyanovaleric acid), 2-(tert-butylazo)-2-cyanopropane, 2,2′-azobis(2,4,4-trimethylpentane), 2,2′-azobis(2-methylpropane), and dimethyl 2,2′-azobis(2-methylpropionate).

The content of the thermal polymerization initiator is preferably in the range of 1.2 to 10 parts by mass per 100 parts by mass of all components excluding the thermal polymerization initiator. When the content of the thermal polymerization initiator is 1.2 parts by mass or more with respect to 100 parts by mass of all components excluding the thermal polymerization initiator, a rapid increase in pressure-sensitive adhesive force after a heat treatment can be prevented. When the content is 10 parts by mass or less, the initial peel force can be maintained high. The content of the thermal polymerization initiator is preferably 1.7 parts by mass or more, more preferably 2.0 parts by mass or more, still more preferably 2.5 parts by mass or more, and is preferably 7 parts by mass or less, more preferably 5 parts by mass or less, still more preferably 3 parts by mass or less.

Further, the pressure-sensitive adhesive composition according to the present invention may contain other known additives. For example, polyether compounds of polyalkylene glycol such as polypropylene glycol, a colorant, a pigment powder, a dye, a plasticizer, a silane coupling agent, an adhesiveness imparting agent, a surface lubricant, a leveling agent, a softener, an anti-aging agent, an antioxidant, a light stabilizer, an ultraviolet absorber, a polymerization inhibitor, an inorganic or organic filler, a metal powder, particles, and a foil-like material can be used and added as appropriate depending on the application.

The pressure-sensitive adhesive composition according to the present invention is obtained by mixing an acrylic polymer, a surfactant, and optional components.

A contact angle with water when the pressure-sensitive adhesive composition according to the embodiment of the present invention is formed into a cured film is preferably 80 degrees or less. When the contact angle with water for the cured film is 80 degrees or less, it is possible to reduce the peeling force when peeling the pressure-sensitive adhesive sheet by contact with warm water. The contact angle is more preferably 60 degrees or less, and still more preferably 50 degrees or less. The lower limit thereof is not particularly limited, and is preferably 10 degrees.

### [Pressure-Sensitive Adhesive Sheet]

A pressure-sensitive adhesive sheet according to the present invention includes a pressure-sensitive adhesive layer formed of the above pressure-sensitive adhesive composition on at least one side of a supporting substrate. Examples of a method for forming the pressure-sensitive adhesive layer include a method of applying a pressure-sensitive adhesive composition to a release liner or the like that has been subjected to a peeling treatment, drying and removing the polymerization solvent or the like to form a pressure-sensitive adhesive layer, and then transferring the pressure-sensitive adhesive layer to a supporting substrate, or a method of applying a pressure-sensitive adhesive composition to a supporting substrate, drying and removing the polymerization solvent or the like, and forming a pressure-sensitive adhesive layer on the supporting substrate. Note that, when applying the pressure-sensitive adhesive, one or more solvents other than the polymerization solvent may be added as appropriate.

The substrate that supports (backs) the pressure-sensitive adhesive layer is not particularly limited, and, for example, a resin film, paper, cloth, a rubber sheet, a foam sheet, a metal foil, or a composite thereof can be used. Examples of the resin film include: polyolefin films such as a polyethylene (PE), a polypropylene (PP), and an ethylene-propylene copolymer; polyester films such as polyethylene terephthalate (PET); a vinyl chloride resin film; a vinyl acetate resin film; a polyimide resin film; a polyamide resin film; a fluororesin film; and cellophane. Examples of the paper include Japanese paper, kraft paper, glassine paper, high quality paper, synthetic paper, and top coated paper. Examples of the cloth include woven fabrics and non-woven fabrics made of various fibrous substances alone or blended. Examples of the fibrous substances include cotton, a staple fiber, Manila hemp, pulp, rayon, an acetate fiber, a polyester fiber, a polyvinyl alcohol fiber, a polyamide fiber, and a polyolefin fiber. Examples of the rubber sheet include a natural rubber sheet and a butyl rubber sheet. Examples of the foam sheet include a foamed polyurethane sheet and a foamed polychloroprene rubber sheet. Examples of the metal foil include an aluminum foil and a copper foil.

Note that, the non-woven fabric here is a concept that refers to a non-woven fabric for pressure-sensitive adhesive sheets, which is mainly used in the field of pressure-sensitive adhesive tapes and other pressure-sensitive adhesive sheets, and refers to a non-woven fabric (sometimes referred to as “paper”) that is typically prepared using a general paper machine. In addition, the resin film here is typically a non-porous resin sheet, and is a concept that is distinguished from, for example, the non-woven fabric (that is, it does not include the non-woven fabric). The resin film may be an unstretched film, a uniaxially stretched film, or a biaxially stretched film.

The thickness of the supporting substrate is not particularly limited, and is preferably 5 μm to 200 μm from the viewpoint of preventing the pressure-sensitive adhesive sheet from being excessively thick. When the thickness of the supporting substrate is 5 μm or more, the pressure-sensitive adhesive sheet has excellent handling properties (handleability) and processability. In addition, when the thickness of the supporting substrate is 200 μm or less, it is possible to reduce the weight and the thickness of the pressure-sensitive adhesive sheet. The thickness of the supporting substrate is more preferably 7 μm or more, still more preferably 10 μm or more, and is more preferably 100 μm or less, still more preferably 50 μm or less.

As the release liner, a silicone release liner is preferably used. In the step of applying the pressure-sensitive adhesive composition according to the present invention on such a liner and performing drying to form a pressure-sensitive adhesive layer, an appropriate method may be adopted as a method for drying the pressure-sensitive adhesive depending on the purpose. Preferably, a method of heating and drying the coating film is used. The temperature in heating and drying is preferably 60° C. to 150° C., more preferably 70° C. to 140° C., and particularly preferably 80° C. to 130° C. When the heating temperature is within the above range, a pressure-sensitive adhesive having excellent adhesive properties can be obtained.

As the drying time, an appropriate time can be adopted as needed. The drying time is preferably 1 minute to 10 minutes, more preferably 2 minutes to 7 minutes, and particularly preferably 3 minutes to 5 minutes.

In addition, the pressure-sensitive adhesive layer can be formed on the surface of the substrate after forming an anchor layer or a surface treatment layer or performing various adhesion-promoting treatments such as a corona treatment and a plasma treatment. The surface of the pressure-sensitive adhesive layer may be subjected to an adhesion-promoting treatment.

Various methods can be used as the method for forming the pressure-sensitive adhesive layer. Specific examples thereof include methods such as an extrusion coating method using a roll coat, a kiss roll coat, a gravure coat, a reverse coat, a roll brush, a spray coat, a dip roll coat, a bar coat, a knife coat, an air knife coat, a curtain coat, a lip coat, and a die coater.

The thickness of the pressure-sensitive adhesive layer is not particularly limited, and is preferably 2 μm to 200 μm from the viewpoint of preventing the pressure-sensitive adhesive sheet from being excessively thick. When the thickness of the pressure-sensitive adhesive layer is 2 μm or more, adhesion to the adherend is ensured and the impact resistance is easily obtained. In addition, when the thickness of the pressure-sensitive adhesive layer is 200 μm or less, it is possible to reduce the weight and the thickness of the pressure-sensitive adhesive sheet. The thickness of the pressure-sensitive adhesive layer is more preferably 5 μm or more, still more preferably 10 μm or more, and is more preferably 100 μm or less, still more preferably 50 μm or less.

When the pressure-sensitive adhesive layer is exposed after being formed on the supporting substrate, the pressure-sensitive adhesive layer may be protected with a sheet (separator) subjected to a peeling treatment until the pressure-sensitive adhesive layer is put into practical use.

### [Peeling Method for Pressure-Sensitive Adhesive Sheet]

The pressure-sensitive adhesive sheet can be used for various applications, for example, heat-resistant pressure-sensitive adhesive tapes such as a heat-resistant masking tape and an industrial tape, heat-resistant pressure-sensitive adhesive tapes such as a semiconductor tape, and heat-resistant pressure-sensitive adhesive tapes such as an optical tape.

Examples of the adherend include optical glass plates such as an anhydrous alkali glass, metal layers such as an ITO layer, metal plates, synthetic resin plates, synthetic resin films, and synthetic resin sheets, but are not particularly limited.

The pressure-sensitive adhesive sheet according to the present invention is attached to an adherend, and the pressure-sensitive adhesive sheet is peeled from the adherend after the adherend is subjected to a heat treatment at 130° C. to 250° C. In the present invention, the adherend to which the pressure-sensitive adhesive sheet is attached is brought into contact with warm water at 40° C. to 90° C., and the adherend and the pressure-sensitive adhesive sheet are peeled at an interface therebetween. When the adherend to which the pressure-sensitive adhesive sheet is attached is brought into contact with warm water, the pressure-sensitive adhesive layer of the pressure-sensitive adhesive sheet swells with warm water, and the pressure-sensitive adhesive sheet can be peeled from the adherend with a small force. Therefore, in a case where a heat treatment is performed at a temperature of 130° C. or higher in the production of various industrial products, when the pressure-sensitive adhesive sheet according to the present invention is attached to a portion to be avoided from direct heating, during the heat treatment, the adherend is protected, and when the pressure-sensitive adhesive sheet is to be peeled, by being brought into contact with warm water, the pressure-sensitive adhesive sheet can be peeled from the surface of the adherend with a small peeling force.

The temperature in the heat treatment for the adherend is more preferably 150° C. to 250° C., and still more preferably 170° C. to 200° C., and the time in the heat treatment is more preferably 5 minutes to 5 hours, and still more preferably 10 minutes to 3 hours.

A method for bringing the adherend to which the pressure-sensitive adhesive sheet is attached into contact with warm water is not particularly limited, and examples thereof include a method of immersing an adherend with a pressure-sensitive adhesive sheet in warm water, a method of pouring warm water onto an adherend with a pressure-sensitive adhesive sheet, and a method of spraying warm water onto an adherend with a pressure-sensitive adhesive sheet. Among them, a method of immersion in warm water using a constant temperature water bath or the like is preferred from the viewpoint of easily keeping the temperature of the warm water constant.

The water temperature of the warm water is 40° C. to 90° C. When the water temperature is 40° C. or higher, the pressure-sensitive adhesive composition swells easily, making it easy to peel, and when the water temperature is 90° C. or lower, there is no need to excessively heat the water, resulting in good production efficiency. The water temperature of the warm water is preferably 50° C. or higher, more preferably 60° C. or higher, and is preferably 85° C. or lower, more preferably 80° C. or lower.

In addition, the time during which the pressure-sensitive adhesive sheet is in contact with warm water is preferably 1 minute or longer. When the contact with warm water is 1 minute or longer, the pressure-sensitive adhesive layer sufficiently swells, so that the pressure-sensitive adhesive sheet can be easily peeled from the adherend.

The contact time with warm water is more preferably 1 minute to 120 minutes, and still more preferably 5 minutes to 60 minutes, from the viewpoint of treatment efficiency.

### EXAMPLES

Hereinafter, the present invention will be further described with reference to Examples and Comparative Examples, but the present invention is not limited to the following Examples.

Acrylic polymers A to E were prepared according to the following procedure. Table 1 shows the amount of the monomer charged in each polymer.

### <Preparation of Acrylic Polymer A>

To a reaction vessel equipped with a cooling tube, a nitrogen introduction tube, a thermometer, and a stirring device, 85 parts by mass of methoxyethyl acrylate (hereinafter referred to as “MEA”), 5 parts by mass of 4-hydroxybutyl acrylate (hereinafter referred to as “4HBA”), 10 parts by mass of n-vinyl-2-pyrrolidone (hereinafter referred to as “NVP”), 0.5 parts by mass of acrylic acid (hereinafter referred to as “AA”), 0.2 parts by mass of benzoyl peroxide, and 65 parts by mass of toluene were charged, and a polymerization treatment was carried out at 61° C. for 6 hours in a nitrogen stream to obtain an acrylic polymer A having a structure shown below. Note that, in the following structure, k, l, m, and n were the mass ratios of respective monomers, and k=84.6, l=9.9, m=5.0, and n=0.5. In addition, the weight average molecular weight (Mw) of the acrylic polymer A was 550,000.

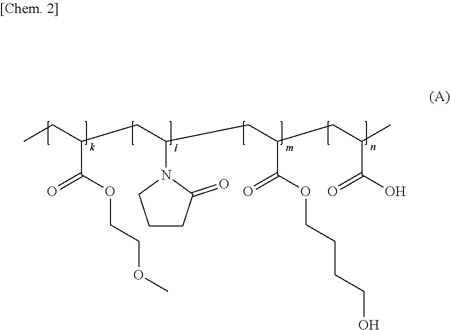

### <Preparation of Acrylic Polymer B>

An operation same as in the method for preparing the acrylic polymer A was performed to obtain an acrylic polymer B having a structure shown below, except that MEA was changed to ethoxyethoxyethyl acrylate (hereinafter referred to as “EEEA”). Note that, in the following structure, k, l, m, and n were the mass ratios of respective monomers, and k=84.6, 1=9.9, m=5, and n=0.5. In addition, the weight average molecular weight (Mw) of the 0 acrylic polymer B was 410,000.

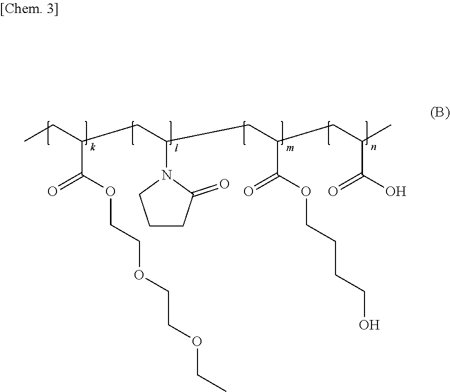

### <Preparation of Acrylic Polymer C>

To a reaction vessel equipped with a cooling tube, a nitrogen introduction tube, a thermometer, and a stirring device, 95 parts by mass of MEA, 5 parts by mass of AA, 0.2 parts by mass of benzoyl peroxide, and 65 parts by mass of toluene were charged, and a polymerization treatment was carried out at 61° C. for 6 hours in a nitrogen stream to obtain an acrylic polymer C having a structure shown below. Note that, in the following structure, m and n were the mass ratios of respective monomers, and m=95, and n=5. In addition, the weight average molecular weight (Mw) of the acrylic polymer C was 800,000.

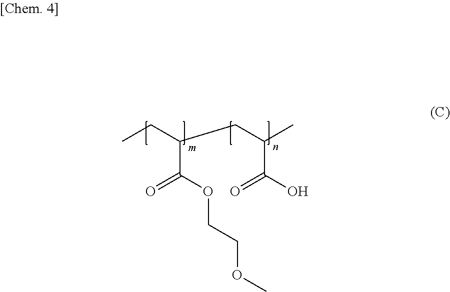

### <Preparation of Acrylic Polymer D>

An operation same as in the method for preparing the acrylic polymer C was performed to obtain an acrylic polymer D having a structure shown below, except that MEA was changed to n-butyl acrylate (hereinafter referred to as “BA”). Note that, in the following structure, m and n were the mass ratios of respective monomers, and m=95, and n=5. In addition, the weight average molecular weight (Mw) of the acrylic polymer D was 650,000.

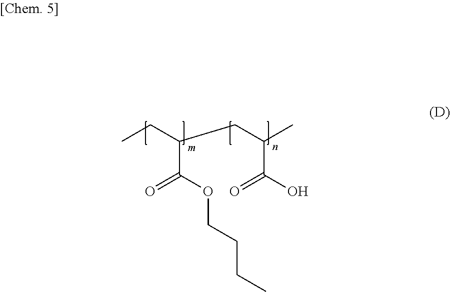

### <Preparation of Acrylic Polymer E>

An operation same as in the method for preparing the acrylic polymer C was performed to obtain an acrylic polymer E having a structure shown below, except that AA was changed to 4HBA. Note that, in the following structure, m and n were the mass ratios of respective monomers, and m=95, and n=5. In addition, the weight average molecular weight (Mw) of the acrylic polymer E was 460,000.

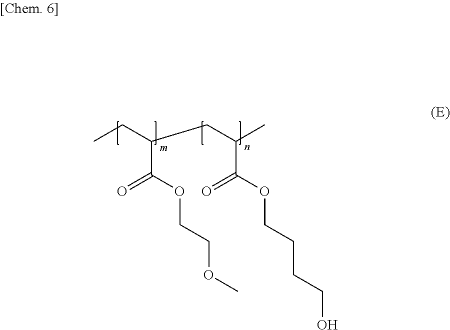

TABLE 1
(Unit: part by mass)

| | | Acrylic polymer | | | | |
|---|---|---|---|---|---|---|
| Monomer | Tg | A | B | C | D | E |
| Methoxyethyl acrylate (MEA) | −50° C. | 85 | — | 95 | | 95 |
| Ethoxyethoxyethyl | −67° C. | — | 85 | — | — | — |
| acrylate (EEEA) | | | | | | |
| n-Butyl acrylate (BA) | −55° C. | — | — | — | 95 | — |
| 4-Hydroxybutyl acrylate (4HBA) | −32° C. | 5 | 5 | — | — | 5 |
| n-Vinyl-2-pyrrolidone (NVP) | 80° C. | 10 | 10 | — | — | — |
| Acrylic acid (AA) | 106° C. | 0.5 | 0.5 | 5 | 5 | — |

### Example 1

To 100 parts by mass of the acrylic polymer A, 0.5 parts by mass of an epoxy-based crosslinking agent (product name “TETRAD-C”, manufactured by Mitsubishi Gas Chemical Trading, Inc.), 1 part by mass of a polyisocyanate compound (product name “Coronate L”, manufactured by Nippon Polyurethane Industries, Co., Ltd.), and 5 parts by mass of polyoxyethylene sorbitan monolaurate (product name “RHEODOL TW-L120”, manufactured by Kao Corporation) as a nonionic surfactant were added, to prepared a pressure-sensitive adhesive solution.

The obtained pressure-sensitive adhesive solution was applied onto a silicone-treated surface of a PET release liner and heated at 80° C. for 5 minutes to form a pressure-sensitive adhesive layer having a thickness of 10 μm. Next, a PET film having a thickness of 12 μm was attached to the surface of the pressure-sensitive adhesive layer. Thereafter, it was stored at 50° C. for 24 hours to prepare a pressure-sensitive adhesive sheet 1.

### Example 2

A pressure-sensitive adhesive sheet 2 was prepared in the same manner as in Example 1, except that the acrylic polymer A was changed to the acrylic polymer B, unlike in Example 1.

### Example 3

A pressure-sensitive adhesive sheet 3 was prepared in the same manner as in Example 1, except that the amount of polyoxyethylene sorbitan monolaurate added was changed to 1.5 parts by mass, and 1.5 parts by mass of polypropylene glycol (Mn4000, manufactured by Sigma-Aldrich) was added, unlike in Example 1.

### Example 4

A pressure-sensitive adhesive sheet 4 was prepared in the same manner as in Example 1, except that the acrylic polymer A was changed to the acrylic polymer C, unlike in Example 1.

### Comparative Example 1

A pressure-sensitive adhesive sheet 5 was prepared in the same manner as in Example 1, except that the acrylic polymer A was changed to the acrylic polymer D, unlike in Example 1.

### Comparative Example 2

A pressure-sensitive adhesive sheet 6 was prepared in the same manner as in Example 1, except that the acrylic polymer A was changed to the acrylic polymer E, unlike in Example 1.

### Comparative Example 3

A pressure-sensitive adhesive sheet 7 was prepared in the same manner as in Example 1, except that no surfactant was added, unlike in Example 1.

### <Contact Angle>

The pressure-sensitive adhesive sheet was cut into a strip having a width of 20 mm and a length of 50 mm, 2 μL of ion-exchanged water was dropped onto the adhesive surface of the pressure-sensitive adhesive sheet in an environment of 25° C.×50% RH, and the contact angle was measured after 10 seconds. The contact angle was measured using an image obtained using a contact angle meter (DMo-501 manufactured by Kyowa Interface Science Co., Ltd.) using the multifunctional integrated analysis software FAMAS manufactured by Kyowa Interface Science Co., Ltd. by fitting with the method “liquid application method” and the method “θ/2 method”.

### <Peel Force Evaluation>

### 1. Measurement of Initial Pressure-Sensitive Adhesive Force

The pressure-sensitive adhesive sheet was cut into a strip having a width of 20 mm and a length of 100 mm, and the strip was pasted on an alkali glass plate (thickness: 1.35 mm, polished blue plate edge product) manufactured by Matsunami Glass Ind., Ltd. using a roller (a pressure force of 2 kg/10 mm). The obtained product was subjected to an autoclave treatment at 50° C. and 5 atm for 30 minutes, followed by being left to stand at normal temperature and pressure for 30 minutes, to obtain a test specimen.

The test specimen was subjected to peeling at a peeling angle of 180 degrees and a peeling speed of 300 mm/min in an environment of 25° C.×50% RH, and the pressure-sensitive adhesive force at this time was measured using a tensile testing machine (EZ-S 500N manufactured by SHIMAZU).

### 2. Measurement of Post-Heating Pressure-Sensitive Adhesive Force

The test specimen obtained above was heated in an oven at 180° C. for 1 hour, and then left to stand at normal temperature and pressure for 30 minutes, and the pressure-sensitive adhesive force was measured using a tensile testing machine in the same manner as above.

3. Measurement of Pressure-Sensitive Adhesive Force after Immersion in Warm Water

The test specimen obtained above was heated in an oven at 180° C. for 1 hour, then left to stand at normal temperature and pressure for 30 minutes, and then immersed in warm water at 60° C. for 1 hour, then the moisture on the surface was wiped off with a waste cloth, and the pressure-sensitive adhesive force was measured using a tensile testing machine in the same manner as above.

### <Adhesive Residue Evaluation>

In the above “3. Measurement of pressure-sensitive adhesive force after immersion in warm water”, a case where there is no adhesive residue on the glass surface during peeling after immersion in warm water is evaluated as “OK (good)”, and a case where the adhesive residue is observed is evaluated as “NG (not good)”.

The results are shown in Table 2.

TABLE 2

| | | | | | | Pressure-sensitive adhesive force | | | |
|---|---|---|---|---|---|---|---|---|---|
| | | | | | | | | Pressure- | |
| | | | | | | | Pressure- | sensitive | |
| | | | | | | | sensitive | adhesive | |
| | | | | | | | adhesive | force | |
| | | | | | | | force | (N/20 mm) after | |
| | | | | | | Initial | (N/20 mm) | immersion in | |
| | Acrylic polymer | | | | | Pressure- | after | warm water at | |
| | | Molecular | | | Contact | sensitive | heating at | 60° C. | Adhesive |
| | | weight | Surfactant | | angle | adhesive force | 180° C. | for 1 h | residue |
| | Type | Mw | Surfactant 1 | Surfactant 2 | (degree) | (N/20 mm) | for 1 h | after heating | evaluation |
| Example 1 | (A) | 550.000 | RHEODOL TW-L120 | No | 21 | 2.8 | 5.5 | 1 | OK |
| | | | 5 parts | | | | | | |
| Example 2 | (B) | 410.000 | RHEODOL TW-L120 | No | 48 | 0.8 | 1.8 | 0.3 | OK |
| | | | 5 parts | | | | | | |
| Example 3 | (A) | 550.000 | RHEODOL TW-L120 | PPG | 23 | 3.7 | 5.3 | 1.8 | OK |
| | | | 1.5 parts | 1.5 parts | | | | | |
| Example 4 | (C) | 800.000 | RHEODOL TW-L120 | No | 15 | 1.8 | 4.2 | 1.6 | OK |
| | | | 5 parts | | | | | | |
| Comparative | (D) | 650.000 | RHEODOL TW-L120 | No | 106 | 0.7 | 2.8 | 2.2 | OK |
| Example 1 | | | 5 parts | | | | | | |
| Comparative | (E) | 460.000 | RHEODOL TW-L120 | No | 22 | 2.7 | 4.8 | 0.8 | NG |
| Example 2 | | | 5 parts | | | | | | |
| Comparative | (A) | 550.000 | No | No | 20 | 5 | 7.4 | 2.7 | NG |
| Example 3 | | | | | | | | | |

It is found that, in Examples 1 to 4, the initial pressure-sensitive adhesive force is excellent and the pressure-sensitive adhesive force tends to increase after heating, and due to the contact with warm water, the pressure-sensitive adhesive force is lower than the initial pressure-sensitive adhesive force, making the peeling easier. In addition, no adhesive residue is observed after the peeling, indicating excellent peelability. In contrast, in Comparative Example 1, after the contact with warm water, the pressure-sensitive adhesive force is not equal to or lower than the initial pressure-sensitive adhesive force, and the pressure-sensitive adhesive force cannot be decreased. In Comparative Examples 2 and 3, due to the contact with warm water, the pressure-sensitive adhesive force is decreased, but the adhesive residue is observed after the peeling.

While the present invention has been described in detail with reference to specific embodiments, it will be apparent to those skilled in the art that various changes and modifications can be made without departing from the spirit and scope of the present invention. The present application is based on a Japanese Patent Application (No. 2021-160104) filed on Sep. 29, 2021, the contents of which are incorporated herein by reference.

1. A pressure-sensitive adhesive composition comprising:
an acrylic polymer containing a structural unit of an alkoxy group-containing (meth)acrylate monomer as a main component and containing, with respect to 100 parts by mass of all components of monomer structural units, 1 to 40 parts by mass of a structural unit of a polymerizable monomer having a homopolymer Tg of 0° C. or higher; and
a surfactant.

2. The pressure-sensitive adhesive composition according to claim 1, wherein the surfactant is a nonionic surfactant.

3. The pressure-sensitive adhesive composition according to claim 1, wherein the alkoxy group-containing (meth)acrylate monomer is at least one selected from the group consisting of methoxyethyl acrylate, ethoxyethoxyethyl acrylate, polyethylene glycol acrylate, and polypropylene glycol acrylate.

4. The pressure-sensitive adhesive composition according to claim 1, wherein a contact angle with water when the pressure-sensitive adhesive composition is formed into a cured film is 80 degrees or less.

5. A pressure-sensitive adhesive sheet comprising:
a pressure-sensitive adhesive layer formed of the pressure-sensitive adhesive composition according to claim 1.

6. A peeling method for a pressure-sensitive adhesive sheet, which is for peeling the pressure-sensitive adhesive sheet according to claim 5 which is attached to an adherend, the peeling method comprising:
bringing the adherend, to which the pressure-sensitive adhesive sheet is attached and which is subjected to a heat treatment at 130° C. to 250° C., into contact with warm water at 40° C. to 90° C. and peeling the adherend and the pressure-sensitive adhesive sheet at an interface therebetween.

7. The peeling method for a pressure-sensitive adhesive sheet according to claim 6, wherein the adherend to which the pressure-sensitive adhesive sheet is attached is brought into contact with the warm water for 1 minute or longer.
